(19) United States
(12) Patent Application Publication
(10) Pub. No.: US 2022/0331824 A1
(43) Pub. Date: Oct. 20, 2022

(54) Fluid Dispenser

(71) Applicant: RAEPAK LIMITED, Norwich Norfolk (GB)

(72) Inventor: Paterson John Andrew, Norwich (GB)

(21) Appl. No.: 17/763,711

(22) PCT Filed: Sep. 24, 2020
(86) PCT No.: PCT/GB2020/052314

§ 371 Date: Mar. 25, 2022

(30) Foreign Application Priority Data
Sep. 25, 2019 (GB) 1913822.1
Dec. 20, 2019 (GB) 1918995.0

(51) Int. Cl. B05B 11/00; F16F 1/02; F16F 1/373; F16F 9/04

(52) U.S. Cl. CPC B05B 11/3074; B05B 11/3077; F16F 1/025; F16F 1/373; F16F 9/0418; F16F 9/0427; A47K 5/1205

(57) ABSTRACT

A fluid dispenser having a fluid inlet and a fluid outlet; and a pump for drawing fluid from a fluid source via the fluid inlet towards the fluid outlet; wherein the pump has a housing and a spring adapted to bias the pump away from a compressed position and towards a rest position; the spring being situated at least partially within the housing; and wherein the spring comprises one or more resiliently deformable polymer units.

### FIELD OF THE INVENTION

The invention relates to fluid dispensers and/or air springs suitable for such dispensers.

### BACKGROUND TO THE INVENTION

Fluid dispensers for dispensing cleaning, toiletries, cosmetic and food related products, for example, are well known and are present in most households and workplaces.

Typically, a fluid dispenser is connected to a vessel and incorporates a piston for drawing fluid from the vessel to an outlet. Fluid dispensers comprise several parts, some of which move in relation to one another with or against the action of a spring. Springs used in known fluid dispensers are conventional metal coil springs. Typically, part of the dispenser extends through the opening of a coil spring to minimise the size of the dispenser.

Metal springs make it difficult or impossible to straightforwardly recycle fluid dispensers. Most fluid dispensers, particularly disposable dispensers, are made mostly of a plastic and cannot be recycled when containing a metal spring due to the complexities associated with the separation of the metal spring from the dispenser.

Springs are usually housed within the dispenser and it is not easy for a user to dismantle a dispenser after use to separate and dispose of different recyclable and non-recyclable parts. This is particularly pertinent given that is it generally expected that manufacturers and end users should recycle as much material as possible.

There have been previous attempts to provide fluid dispensers made completely of recyclable plastic materials. Said dispensers do away with a metal coil spring and instead comprise a concertinaed housing to provide bellows giving a spring action.

Those previous attempts to remove a metal coil spring result in fluid dispensers which are far removed from the fluid dispensers commonly used and requires a significant number of design and manufacturing changes. It is thus not feasible to incorporate the features of these all-plastic fluid dispensers into existing or conventionally used fluid dispensers which disrupts the manufacturing process and adds to the cost and organisational burden of retooling etc. The overall manufacturing burden is therefore greater, which is particularly important given the relatively disposable nature of many fluid dispensers.

Concertinaed housings also undesirably trap dirt and congealed soap, for example where the dispenser is a liquid soap dispenser. Thus, over time, the function of a dispenser is impaired.

U.S. Pat. No. 5,363,993 shows a prior art dispenser with exposed bellows as part of a knob. The spring can therefore not be deemed to be wholly internal. The wall of the knob 10 is in the same plane as the wall of the bellows which are therefore exposed. These external surfaces of the bellows can, consequently, be a location where fluid such as hand wash, creams may accumulate during use. Clearly, a substantial gap between wall and bellows is present in each prior art embodiment.

U.S. Pat. No. 5,316,198 shows a dispenser includes a spring which is a sealed gas filled chamber around which the product must necessarily travel during the dispensing phase. Consequently, the gas filled spring is directly exposed to the produce which will reduce its effectiveness.

WO1990003849 fails to show polymer units which surround a stem through which fluid is drawn between a fluid inlet and a fluid outlet. Instead, the bellows are directly exposed to the liquid or other fluid and a displaceable piston is provided within the boundaries of the bellows.

CN202112989 concerns a foam pump which requires a helicoidal spring. Furthermore, the spring is not around a liquid dispensing stem.

GB1521665 not only incorporates several metal helicoidal springs, it also fails to incorporate a stem extending along the entire length of the spring.

EP0340724 also fails to incorporate a stem which extends the entire length of a spring whilst it also requires the spring to sit directly in contact with the fluid which is to be dispensed.

It is an aim of the present invention to provide an improved fluid dispenser.

### SUMMARY OF THE INVENTION

In a broad independent aspect, the invention provides a fluid dispenser having a fluid inlet and a fluid outlet; and a pump for drawing fluid from a fluid source via the fluid inlet towards the fluid outlet; wherein the pump has a housing and a spring adapted to bias the pump away from a compressed position and towards a rest position; the spring being situated at least partially within the housing; and wherein the spring comprises one or more resiliently deformable polymer units.

The spring comprising one or more resiliently deformable polymer units improves the spring action of the fluid dispenser and allows the spring to be recycled with the rest of the dispenser, by contrast to a conventional fluid dispenser housing a metal spring. The entire fluid dispenser of the present invention can be recycled together as part of a plastics recycling regime.

Moreover, the spring can occupy the position of a conventional metal coil spring within known widely used fluid dispensers whilst being recyclable with the rest of the dispenser. Providing a fluid dispenser wherein the spring is housed at least partially within the housing protects the spring from damage or from collecting dirt or congealed dispensed fluids during use.

The or each unit has a circumferential wall and the circumferential wall may be substantially without a cavity. A spring with this configuration is more straightforward to manufacture, and provides a reliable and effective spring action. The spring may also provide improved load capacity, quieter operation, more straightforward installation into a fluid dispenser, and improved reliability—i.e. longer life and improved fatigue characteristics over known devices.

The spring may have a substantially non-helical arrangement.

The spring may comprise a single resiliently deformable polymer unit which extends along a longitudinal axis of the fluid dispenser. The spring may comprise a plurality of vertically stacked units. Providing a spring having several units which are stacked one on top of another improves the stability and performance of the pump. The units may be joined to one another such that the spring is formed as a single piece.

Where the spring comprises a plurality of vertically stacked units, the or each unit may have a substantially circular vertical cross section.

The spring may be concertinaed, wherein the or each unit comprises a first end and a second end, the circumferential wall of each unit decreasing in diameter towards each end of the respective unit. A concertinaed spring provides the fluid dispenser with a reliable and robust spring action because as the spring is compressed, the spring deforms in predetermined locations.

The spring may comprise one or more resiliently deformable gas-fillable units.

The resiliently deformable material of the spring and the spring having one or more gas-fillable units together provide an improvement over an arrangement which just provides a resiliently deformable element such as a conventional metal coil spring.

The or each unit of the spring acts to bias the pump towards the rest position. More specifically, the gas fillable and resiliently deformable nature of the or each unit provides an improved spring action. The spring may thus be formed of a recyclable material which is of a similar material to the rest of the fluid dispenser. Therefore, the dispenser does not need to be dismantled before being disposed of in an eco-friendly way.

This configuration is particularly advantageous because the spring provides a reliable and effective means for biasing the pump towards a rest position. The spring can occupy the position of a conventional metal coil spring within known widely used fluid dispensers whilst being recyclable with the rest of the dispenser.

In certain embodiments, the spring may also provide improved load capacity, quieter operation, more straightforward installation into a fluid dispenser, and improved reliability— i.e. longer life and improved fatigue characteristics over known devices. When the pump is urged towards the compressed position, against the bias of the spring, fluid is expelled from the fluid outlet. When the pump is urged towards the rest position by the action of the spring, fluid ceases to be expelled from the outlet and fluid is drawn up from a fluid source into the fluid dispenser ready for the next compression action.

Locating the spring at least partially within the housing avoids the risk that dirt or a fluid product gets stuck to the spring which would impair the performance of the dispenser. The housing also shields the spring from potential damage. For example, if the fluid dispenser is dropped the housing provides a level of protection to the spring.

The spring may be entirely contained within the housing. Locating the spring entirely within the housing improves the performance of the spring because it is shielded from the outside environment. The spring is also less likely to be damaged.

The spring may comprise a single resiliently deformable gas-fillable unit which extends along a longitudinal axis of the fluid dispenser. The spring may have a first end closest to the fluid inlet and a second end closest to the fluid outlet. The spring may comprise a plurality of resiliently deformable gas-fillable units which are adjacently arranged along a longitudinal axis of the fluid dispenser. Providing a spring having several units which are stacked one on top of the other improves the stability and performance of the pump. The spring may comprise two units which are arranged one on top of the other.

The spring may be sealed from the outside environment. The spring may be in fluid communication with the outside environment.

Adjacent units of the spring may be in fluid communication with one another and sealed from the outside environment. Adjacent units of the spring may be in fluid communication with one another and the outside environment. Alternatively, adjacent units of the spring may be sealed from one another and the outside environment. Adjacent units of the spring may be sealed from one another and each in fluid communication with the outside environment.

Where the or each unit is sealed from the outside environment, the pressure of gas inside the spring can be tailored to the product being dispensed or the pump action desired by a manufacturer or operator, when forming the spring for example.

The or each unit of the spring may comprise a circumferential wall. The circumferential wall of each unit may have a substantially constant diameter along a longitudinal axis of the spring. A compression force applied by a user may thus be roughly evenly spread across the spring for improved performance. The circumferential wall of each unit may have a variable circumferential diameter along the longitudinal axis of the spring. A variable or even a tailored circumferential diameter allows the spring to be tailored to the shape of the dispenser and/or to the position of the spring within the fluid dispenser.

The circumferential wall of each unit may be annular. In other words, the spring may have a substantially ring-shaped cross section.

The or each unit may comprise a first end and a second end, the circumferential wall of the unit decreasing in diameter towards each end of said unit. Each unit may therefore be substantially donut shaped. This configuration is particularly advantageous because the stability of the spring is improved.

The wall of the or each unit of the spring may have an equator, the equator being perpendicular to the longitudinal axis of the fluid dispenser. A perpendicular equator improves the stability of the spring because each of the units expands horizontally when compressed and each unit does not expand at a slant to the longitudinal axis of the dispenser.

The diameter of the spring may be substantially constant along the length of the spring.

The pump may incorporate a fluid chamber, and the spring may be located at least partially within the fluid chamber.

The circumferential wall of each unit may incorporate changes in diameter to form one or more radially extending lobes. The lobes of adjacent units may be aligned to form channels through which fluid may flow. Where the spring is located at least partially within the fluid chamber of the pump, the channels formed by the lobes allow fluid to flow through the fluid chamber between the fluid inlet and the fluid outlet. Each unit may comprise several lobes which are aligned with the lobes of adjacent units to provide several such channels. The channels may extend along substantially the entire length of the spring.

A spring comprising a single unit may have a number of lobes which define said channels.

The or each unit of the spring may comprise three lobes, the lobes of adjacent units being aligned. The spring may therefore have a clover-shaped cross section. Thus, three separate channels are formed by the lobes of adjacent units of the spring to allow fluid to flow straightforwardly through between the fluid inlet and fluid outlet.

The wall thickness of the spring may be substantially constant along the length of the spring. The wall thickness of the spring may be greater towards the fluid outlet than towards the fluid inlet. Alternatively, the wall thickness of the spring may be greater towards the fluid inlet than towards the fluid outlet.

The circumferential wall of a first unit of the spring may have a substantially equal thickness to a further unit. The thickness of a circumferential wall of a first unit may be different to the thickness of the circumferential wall of a second unit which is adjacent to the first unit.

Where the spring comprises a plurality of units, the wall thickness of each unit may be sequentially thinner towards the fluid inlet.

In one embodiment, the resilience of a succession of units may vary so that a lower unit may collapse under pressure first and then subsequent units may collapse in succession. This may be achieved by varying the shape and configuration of each unit for example by varying the thickness of their wall. The height may also be varied to achieve a similar effect.

The spring may comprise an opening which extends between the first and second ends of the spring. The opening provides space for part of the dispenser to extend therethrough, or for fluid to pass through the spring. The or each unit of the spring may be sealed from the opening.

The spring may be coated in a non-stick coating or deposition to minimise the risk of adjacent units sticking to one another or of the spring sticking to the housing. The coating may incorporate talc.

The spring may comprise reinforcing means located between two adjacent units. The reinforcing means may comprise one or more girdles. The reinforcing means improves the strength of the spring.

The fluid dispenser may be formed from one or more materials which are of a similar recyclable type. For example, the fluid dispenser may be formed from one or more plastics which are recyclable together, i.e. without needing to be separated prior to recycling.

The dispenser may have a fluid chamber arranged to contain a volume of fluid; and a tube in fluid communication with the fluid chamber and communicable with a fluid source; wherein the pump comprises a stem in fluid communication with the fluid chamber; and a pump actuator; wherein the pump is arranged to draw fluid from the fluid source into the fluid chamber via the tube when biased towards the rest position, and is further arranged to dispense fluid contained in the fluid chamber from the fluid outlet via the stem when urged towards the compressed position. The spring may be arranged to bias the fluid chamber and actuator apart from one another. This configuration is particularly advantageous because the spring may replace known metal coil springs for improved performance and recyclability.

The dispenser may further comprise a valve which separates the tube and the fluid chamber; the valve being arranged to allow fluid to pass from the tube to the fluid chamber when the pump is biased towards the rest position by the spring; the valve being further arranged to prevent fluid passing from the fluid chamber to the tube when the pump is urged towards the compressed position against the action of the spring. The valve may thus be a one-way or “non-return” valve which prevents fluid from passing from the fluid chamber to the tube. Therefore, the valve prevents fluid from exiting the fluid chamber via the tube and forces fluid from the fluid chamber through the stem when the pump is urged towards the compressed position against the action of the spring. This configuration is particularly advantageous because the spring may replace known metal coil springs for improved performance and recyclability.

The stem may be moveable relative to the fluid chamber along said longitudinal axis. The stem thus causes an increase in pressure within the fluid chamber when the pump is actuated so as to force fluid contained in the fluid chamber towards the fluid outlet via the stem.

The pump may comprise a cavity between the housing and the stem, and the spring is at least partially located in said cavity. The cavity protects the spring and minimises the risk of dirt or a fluid product becoming lodged on the spring, for example between adjacent units of the spring.

The spring may be at least partially located in said fluid chamber. The spring may be connected to an end portion of the stem and end portion of the fluid chamber substantially opposite the stem end portion. Locating the spring inside the fluid chamber protects the spring and minimises the size of the fluid dispenser.

Where the spring comprises one or more lobes forming channels for the flow of fluid, fluid may efficiently flow from the fluid chamber to the stem via the channels defined by the spring units. The spring does not disrupt the flow of fluid through the fluid dispenser.

The liquid dispenser may be made entirely of materials that can be recycled together. Thus, the liquid dispenser can be disposed of in an environmentally friendly way. The dispenser does not need to be dismantled to properly dispose of each of the dispenser's components.

The spring may be made of an elastomer. The spring may be made of a thermoplastic elastomer.

The spring may be made from material selected from the group of: a polyolefin blend (TPO); a polyolefin alloy (TPV); a polyolefin plastomer (POP); a polyolefin elastomer (POE); reactor TPO (R-TPO); a thermoplastic polyolefin; an olefin block copolymer. For example, the spring may be formed from TDS 9077 olefin block copolymer supplied by The Dow Chemical Company. The spring may be made from natural and/or synthetic rubber.

The present inventive concept is also directed to a container comprising a fluid dispenser in accordance with any preceding aspect.

The container may be an airless container. An airless container is a container in which a vacuum is created to draw fluid from a fluid source towards a fluid outlet. The spring provides an airless container which is more effective, reliable and recyclable. The pump may comprise a chamber and means for generating a vacuum inside said chamber.

The present inventive concept is also directed to a spring for a fluid dispenser, wherein the spring comprises one or more resiliently deformable polymer units. The spring is an improvement over conventional metal coil springs for fluid dispensers. The spring of the present inventive concept is recyclable when recycled together with the rest of a fluid dispenser, of compatible material construction.

The or each unit of the spring may be substantially without a cavity.

The spring may comprise one or more resiliently deformable gas-fillable units.

The spring may comprise a single resiliently deformable polymer unit which has a first end and a second end. The spring may comprise a plurality of adjacently arranged units. Providing a spring having several units which are stacked one on top of the other improves the stability and performance of the spring. The spring may comprise two units which are arranged one on top of the other.

The spring may be sealed from the outside environment. The spring may be in fluid communication with the outside environment.

Adjacent units of the spring may be in fluid communication with one another and sealed from the outside environment. Adjacent units of the spring may be in fluid communication with one another and the outside environment. Alternatively, adjacent units of the spring may be sealed from one another and the outside environment. Adjacent units of the spring may be sealed from one another and each in fluid communication with the outside environment.

Where the or each unit is sealed from the outside environment, the pressure of gas inside the spring can be tailored to the product being dispensed or spring performance desired by a manufacturer or operator.

The or each unit of the spring may comprise a circumferential wall. The circumferential wall of each unit may have a substantially constant diameter along a longitudinal axis of the spring. A compression force applied by a user may thus be roughly evenly spread across the spring for improved performance. The circumferential wall of each unit may have an inconstant circumferential diameter along the longitudinal axis of the spring. An inconstant circumferential diameter allows the spring to be tailored to the shape of a fluid dispenser and/or to the position of the spring within a fluid dispenser.

The circumferential wall of each unit may be annular. In other words, the spring may have a substantially ring-shaped cross section.

The or each unit may comprise a first end and a second end, the circumferential wall of the unit decreasing in diameter towards each end of said unit. Each unit may therefore be substantially donut shaped. This configuration is particularly advantageous because the stability of the spring is improved.

The wall of the or each unit of the spring may have an equator, the equator being perpendicular to the longitudinal axis of the fluid dispenser. A perpendicular equator improves the stability of the spring because each of the units expands horizontally when compressed and each unit does not expand at a slant to the longitudinal axis of the dispenser.

The diameter of the spring may be substantially constant along the length of the spring.

The circumferential wall of each unit may incorporate changes in diameter to form one or more radially extending lobes. The lobes of adjacent units may be aligned to form channels through which fluid may flow. Each unit may comprise several lobes which are aligned with the lobes of adjacent units to provide several such channels. The channels may extend along substantially the entire length of the spring.

A spring comprising a single unit may have a number of lobes which define said channels.

The or each unit of the spring may comprise three lobes, the lobes of adjacent units being aligned. The spring may therefore have a clover-shaped cross section. Thus, three separate channels are formed by the lobes of adjacent units of the spring to allow fluid to flow straightforwardly along the length of the spring between the lobes.

The wall thickness of the spring may be substantially constant along the length of the spring. The wall thickness of the spring may be greater towards the first end than towards the second end. Alternatively, the wall thickness of the spring may be greater towards the second end than towards the first end.

The circumferential wall of a first unit of the spring may have a substantially equal thickness to a further unit. The thickness of a circumferential wall of a first unit may be different to the thickness of the circumferential wall of a second unit which is adjacent to the first unit.

Where the spring comprises a plurality of units, the wall thickness of each unit may be sequentially thinner towards the fluid inlet.

The spring may comprise an opening which extends between the first and second ends of the spring. The opening provides space for part of a dispenser to extend therethrough, or for fluid to pass through the spring. The or each unit of the spring may be sealed from the opening.

The spring may be coated in a non-stick coating to minimise the risk of adjacent units sticking to one another. The coating may incorporate talc.

The spring may comprise reinforcing means located between two adjacent units. The reinforcing means may comprise one or more girdles. The reinforcing means improves the strength of the spring.

The spring may be a reversible sleeve spring. The spring may be a convoluted spring.

The spring may be made of a recyclable material. The spring may be made of an elastomer. The spring may be made of a thermoplastic elastomer. The spring may be made from material selected from the group of: a polyolefin blend (TPO); a polyolefin alloy (TPV); a polyolefin plastomer (POP); a polyolefin elastomer (POE); reactor TPO (R-TPO); a thermoplastic polyolefin; an olefin block copolymer. For example, the spring may be formed from TDS 9077 olefin block copolymer supplied by The Dow Chemical Company. The spring may be made from natural and/or synthetic rubber.

The spring may be injection moulded. The spring maybe thermoformed. The spring may be extruded. The spring maybe compression moulded. The spring may be vacuum cast.

In a further independent aspect, the invention provides a fluid dispenser having a fluid inlet and a fluid outlet; and a pump for drawing fluid from a fluid source via the fluid inlet towards the fluid outlet; wherein the pump has a push top with an external wall which surrounds the upper portion of a spring; said push top being displaceable within a housing; said spring being adapted to bias the pump away from a compressed position and towards a rest position; the spring being, whilst in use, wholly internal as it is situated entirely within the combination of said push top and said housing; wherein the spring is wholly formed of one or more resiliently deformable polymer units; and said polymer units surround a stem through which fluid is drawn between said fluid inlet and said fluid outlet; said stem extending along the entire length of said spring; whereby said stem separates said spring from said fluid. This aspect may be combined with any preceding or subsequent aspect described herein.

This configuration is particularly advantageous because it protects the spring entirely from being exposed to either external elements where dispensed fluids, cream, and even external dirt or other product could otherwise eventually block the functionality of the spring whilst at the same time it is also protected from the fluid it dispenses as it travels within a stem instead of being directly in contact with the spring as suggested in the prior art. There is therefore a significant improvement to the repeatable functionality of the spring in the specific location provided which will allow for accurate and long-term functionality. It is also further shielded from potential external tampering. With respect to certain embodiments of the invention, because the spring is made wholly of polymeric material, it is particularly suited for recycling with the rest of the dispenser and/or its container as there is now no longer any requirement for the removal of metallic components.

### BRIEF DESCRIPTION OF THE DRAWINGS

The invention will now be described, by way of example only, with reference to the accompanying drawings.

FIG. 1A shows a fluid dispenser in cross section;

FIG. 1B shows the fluid dispenser of FIG. 1A in cross section with a full side view of a spring.

FIG. 2 shows a side elevation view of a spring;

FIG. 3 shows a side perspective view of a spring having four adjacently arranged units.

FIG. 4 shows a part cross sectional view of a spring having two adjacently arranged units.

FIG. 5 shows a dispenser in cross section with a spring in side elevation along its longitudinal axis.

FIG. 6 shows a perspective view of a spring having three lobes defining three channels for the flow of fluid.

FIG. 7 shows a cross section of a spring having lobes defining channels for the flow of fluid.

FIG. 8 shows an airless container and fluid dispenser in cross section.

FIG. 9 shows a further fluid dispenser in cross section.

FIG. 10 shows a spring having cavities in cross section.

FIG. 11 shows a further fluid dispenser in cross section.

FIG. 12 shows a spring without cavities in cross section.

FIG. 13 shows a further fluid dispenser in cross section.

FIG. 14 shows a side view of a spring for a fluid dispenser.

FIG. 15 shows a further embodiment of a spring.

### DETAILED DESCRIPTION OF THE EMBODIMENTS

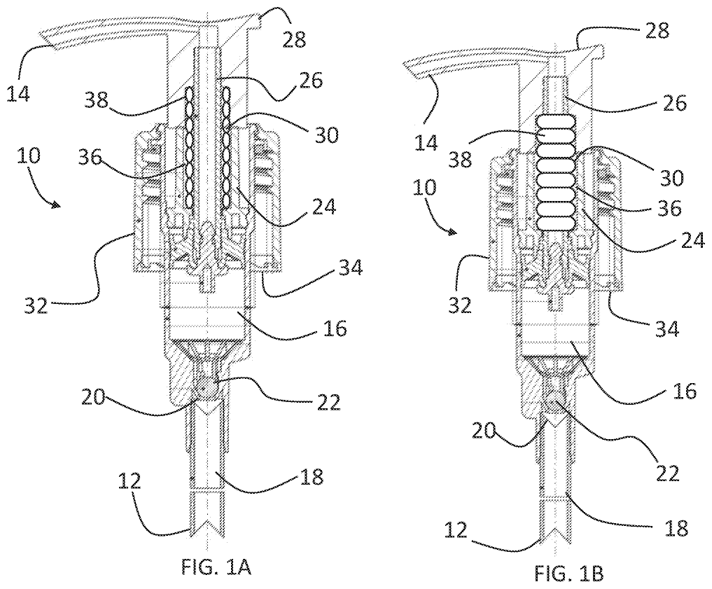

FIG. 1A shows a fluid dispenser 10 for drawing fluid from a fluid source (not shown) via a fluid inlet 12 and urging fluid towards a fluid outlet 14. The fluid dispenser may be used for various fluid products, such as soaps, cosmetics and food products.

The fluid dispenser 10 comprises a fluid chamber 16 and a tube 18. The tube 18 is in fluid communication with the fluid chamber and extends from the fluid chamber 16 towards, in use, a fluid source. The fluid chamber 16 and tube 18 are separated by a valve 20. The valve 20 is a one-way valve which allows fluid to pass from the tube 18 into the fluid chamber 16 but not from the fluid chamber 16 to the tube 18. In the embodiment of FIG. 1A the valve 20 comprises a ball 22 and a narrowed section of the tube 18 which together reversibly form a seal. In use, when the pressure in the fluid chamber 16 is greater than the pressure in the tube 18, a seal is formed between the ball 22 and tube 18 because the ball 18 is forced against the narrowed section of the tube 18.

The dispenser 10 further comprises a pump 24. The pump 24 incorporates a stem 26 which is in fluid communication with and moveable in relation to the fluid chamber 16 along a longitudinal axis of the dispenser 10. The stem 26 has a channel extending between the fluid chamber 16 and the fluid outlet 14. The pump 24 also incorporates a push top 28 which acts as a pump actuator.

The fluid outlet 14 is formed as a spout which is integral with the push top 28. The push top 28 is shaped so that the thumb or finger of an operator can comfortably rest on the push top 28 and apply pressure to the pump 24.

The pump 24 is arranged to urge fluid contained in the fluid chamber 16 up the channel of the stem 26 and out of the fluid outlet 14 as the push top 28 is depressed, i.e. as the pump 24 is moved towards the compressed position against the action of a spring 30. The spring 30 acts to return the pump 24 to the rest position by biasing the pump actuator 28 and fluid chamber 16 apart from one another.

The push top 28 and stem 26 are fixed to one another and both moveable relative to the fluid chamber 16. In use, an operator applies force to the push top 28 to move the stem 26 downwards. As the push top 28 and stem 26 are moved downwards, the spring 30 is compressed and pressure inside the fluid chamber 16 is increased. The increase in pressure causes fluid retained in the fluid chamber 16 to pass through the stem 26 towards the fluid outlet 14. The increased pressure also closes the valve 20 to prevent fluid from passing from the fluid chamber 16 into the tube 18.

When force is released from the push top 28, the spring 30 acts to move the pump 24 towards the rest position, i.e. move the fluid chamber 16 and the pump actuator 28 away from one another. The reduced pressure caused by the spring 30 causes air to enter the fluid outlet 14. The reduced pressure also causes the valve 20 to open and allow fluid to enter the fluid chamber 16 from the tube 18. Thus, the fluid chamber 16 refills with fluid from the fluid source ready for the pump 24 to be used again.

The pump 24 and fluid chamber 16 are enclosed by a housing 32. The housing 32 extends around the circumference of the pump 24 and fluid chamber 16. The housing 32 further comprises a collar 34 for receiving the neck of a container (not shown). The collar 34 incorporates a female screw socket for cooperating with the thread of a container with a screw top. The fluid chamber 16 is shaped so as to sit at least partially within and be bounded by an upper portion of a container.

The spring 30 comprises a plurality of gas-fillable units, such as 38, made of resiliently deformable material. The or each unit of the spring 30 has an elasticity which causes the spring 30 to return to its original shape after a force has been applied to it.

Each of the units of the spring 30 is integrally formed with an adjacent unit. The spring of FIG. 1A comprises eight units which are stacked one on top of the other and are all in fluid communication with one another. The spring 30 is sealed from the outside environment. In other words, a volume of gas is contained in the spring 30 and the resiliently deformable material of the spring 30 allows the spring to be compressed under pressure and to return to a resting shape when pressure is released. The spring 30 has a top end and a bottom end and the spring 30 is sealed at each end. The size of the spring 30, number of units incorporated in the spring 30, the thickness of the or each unit 38 and the resting pressure of the spring 30 can each be modified to adjust the performance of the fluid dispenser 10.

The spring 30 of FIG. 1A and FIG. 1B is annular, i.e. ring shaped, and the stem 26 extends through the opening of the spring 30.

FIG. 1B shows a side view of the spring 30 not in cross section and the rest of the dispenser 10 in cross section. The spring 30 can straightforwardly occupy the position of a conventional helicoidal spring.

In the fluid dispenser 10 of FIGS. 1A and 1B, the pump 24 comprises a cavity 36 between the housing 32 and the stem 26, and the spring 30 is located within the boundary of the housing 32 and within in the cavity 36. The cavity 36 has a shape which is suitable to accommodate the spring 30 when the pump 24 is in the rest position and when the pump 24 is in the compressed position. In other words, the cavity 36 is long enough to accommodate an uncompressed spring 30 and wide enough to accommodate a compressed spring 30 where each of the units temporarily increases in diameter.

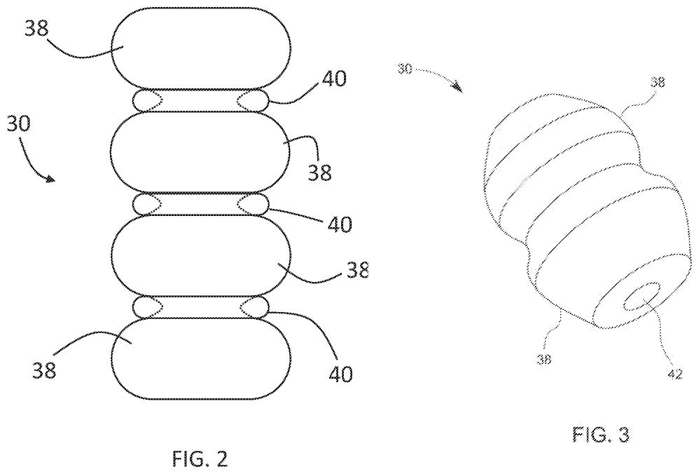

FIGS. 2 and 3 show two embodiments of a spring 30 which may be incorporated in the fluid dispenser of FIGS. 1A and 1B.

FIG. 2 shows a side view of a first embodiment of a spring 30 comprising four units 38. The units 38 are integrally formed and in fluid communication with one another. Girdles 40 extend around the units to reinforce the spring 30. The dotted lines on FIG. 3 show how the units 38 are integral with one another. The spring 30 may be sealed from the outside environment or in fluid communication with the outside environment.

Each unit 38 of the spring 30 of FIG. 2 has a circumferential wall 58 having a substantially constant diameter. The diameter of the wall 58 decreases towards a top end and a bottom end of the unit 38. Each unit 38 has an equator 60 which has a constant diameter.

FIG. 3 shows a perspective view of a second embodiment of a spring 30 comprising two units 38 which are integrally formed and in fluid communication with one another. The spring 30 does not comprise reinforcing girdles. Each unit 38 of the spring 30 of FIG. 3 also has an equator which has a substantially constant diameter. The diameter of each unit 38 decreases towards the top end and bottom end of the unit.

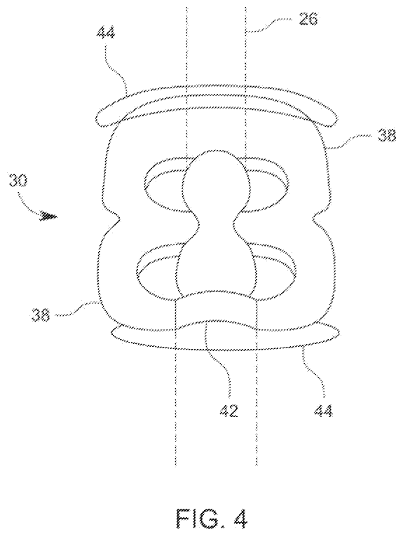

The springs 30 of FIGS. 3 and 4 are annular and comprise an opening 42 (shown only in FIG. 4). A stem of a fluid dispenser 10 may extend through the opening 42. The units 38 of the spring 10 are sealed from the opening 42.

FIG. 4 shows a spring 30 in cross section and being sealed at top and bottom ends. FIG. 4 shows the spring 30 in a relatively compressed position. The spring 30 is annular and comprises an opening 42 through which a stem 26 (shown by the dashed line) can extend. The spring 30 is sealed from the opening 42. The top and bottom ends of the spring 30 are each sealed by a support plate 44.

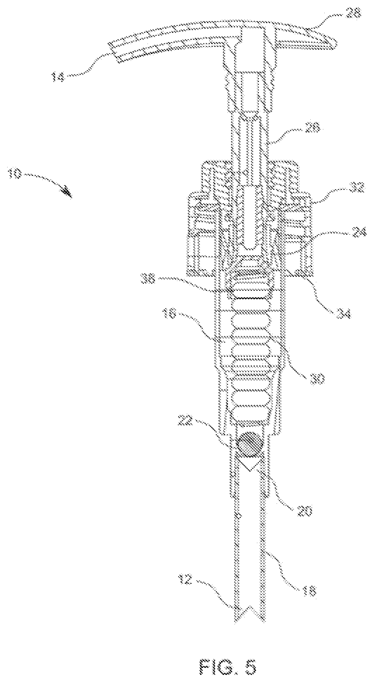

FIG. 5 shows another embodiment of a fluid dispenser 10 sharing most of the features of the fluid dispenser 10 of FIGS. 1A and 1B. The fluid dispenser 10 of FIG. 5 differs from the fluid dispenser of FIGS. 1A and 1B in that it does not comprise a cavity between the housing 32 and the stem 26. Instead, the spring 30 is located inside the fluid chamber 16.

The spring 30 extends between an end portion of the stem 26 and an end of the fluid chamber 16 which is substantially opposite to the stem 26.

In the fluid dispenser 10 of FIG. 5, to allow fluid to pass from tube 18 into the fluid chamber 16 and from the fluid chamber 16 into the stem 26, the spring 30 comprises channels (not shown) at the periphery of the spring 30. Each unit of the spring 30 has a series of lobes which extend around the circumference of the spring 30. The lobes of adjacent units of the spring 30 are aligned to form the channels through which fluid can flow.

In use, when pressure is applied to the push top 28 the stem 26 is forced downwards into the fluid chamber 16. The downward movement of the stem 26 increases the pressure within the fluid chamber 16. The increased pressure forces the valve 20 to close and fluid contained in the fluid chamber 16 to exit via the stem 26. The channels formed by the lobes of the units of the spring 30 allow the fluid to flow from the fluid chamber 16 into the stem 26 and eventually out of the fluid outlet 14.

When pressure is applied to the push top 28 ceases, the spring 30 acts to return to the pump to the rest position. The spring 30 causes the pressure in the fluid chamber 16 to decrease, which opens the valve 20 thereby drawing fluid into the fluid chamber 16 via the tube 18. Once the pump 24 is in the rest position the dispenser 10 is ready to be used again.

The pump 24 may also be forced back towards the compressed position from a position which is between the rest and compressed positions.

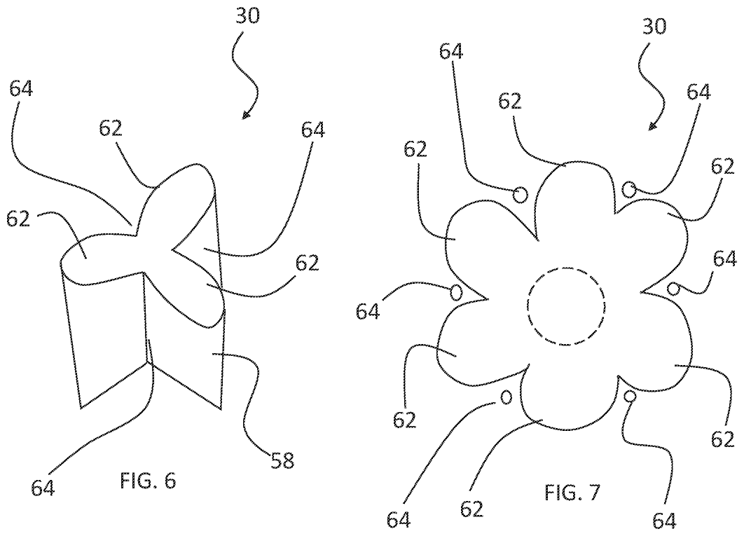

FIG. 6 shows a spring 30 having a single unit in perspective. The spring 30 comprises a circumferential wall 58. The circumferential wall 58 incorporates changes in diameter to form three lobes 62. The lobes 62 together define three channels 64 therebetween. Fluid may thus flow along the channels 64 between the valve 20 and the stem 26 of the fluid dispenser 10.

FIG. 7 shows a spring 30 in cross section, having a plurality of lobes 62 formed by changes in circumferential diameter of the spring 30. The lobes 62 define a plurality of channels 64 through which fluid may flow in use. The spring 30 also incorporates an opening 42 through which the stem 26 of a fluid dispenser, or fluid, may flow in use.

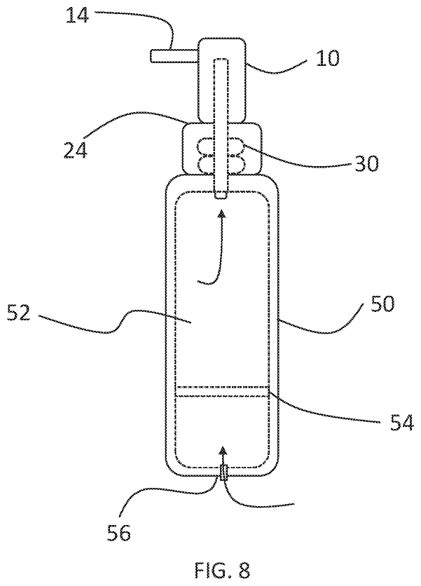

FIG. 8 shows an airless container 50 and fluid dispenser 10 in cross section. The container 50 comprises a fluid chamber 52 and a fluid chamber plate 54. The fluid chamber 52 contains a fluid to be dispensed and no air. The dispenser 10 comprises a pump 24 incorporating a spring 30. The spring 30 biases the pump 24 towards a rest position. As the pump 24 is actuated against the bias of the spring 30 fluid is drawn from the fluid chamber 52 to a fluid outlet 14. The fluid chamber plate 54 is moveable along the length of the container 50 and moves up the length of the container 50 in response to fluid exiting the fluid chamber 52 via the fluid outlet 14. The container 50 further comprises an air intake valve 56. Air enters the air intake valve 56 as the fluid chamber plate 54 rises inside the fluid chamber 52 to replace the space left by the now expelled fluid. This way, a vacuum-type condition is maintained within the container 50.

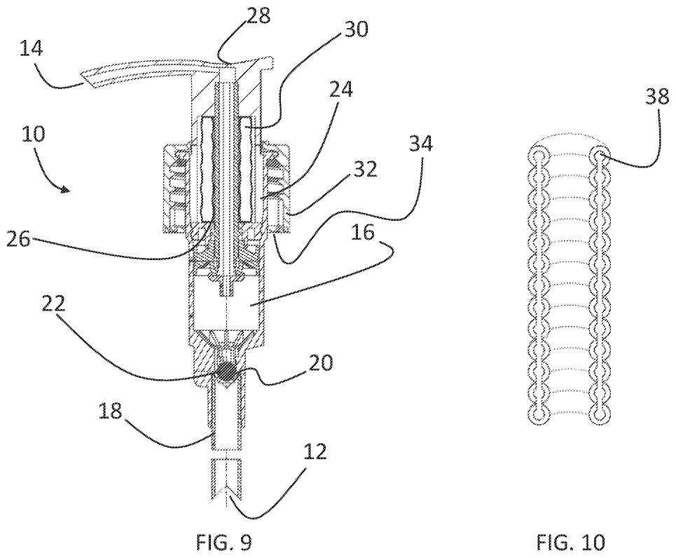

FIG. 9 shows a cross section of a fluid dispenser sharing most of the features of the dispenser of FIGS. 1A and 1B. The spring 30 of the fluid dispenser of FIG. 9 also has a plurality of gas-fillable units 38, wherein each unit of the spring 30 comprises a circumferential cavity. The units 38 are stacked vertically one on top of another to form the spring 30 and adjacent units 38 are in fluid communication with one another, as shown in FIG. 10. Fluid communication may be achieved by an appropriate passage-way or aperture between adjacent portions.

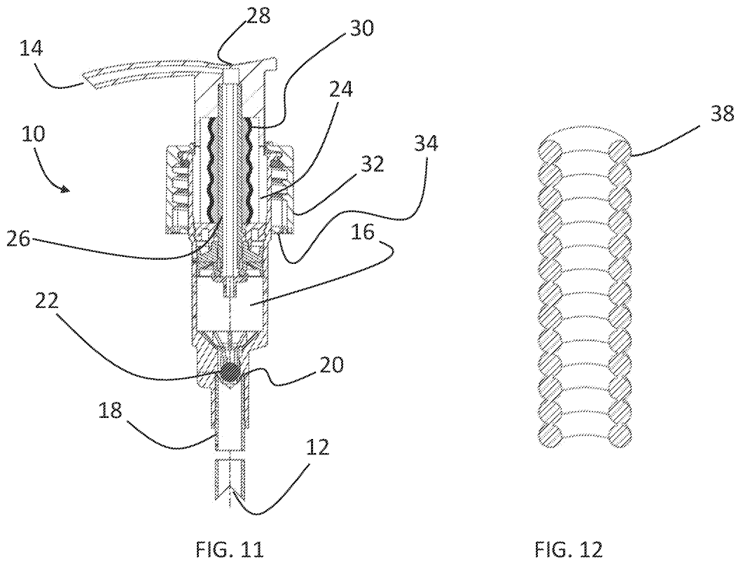

FIG. 11 shows a further fluid dispenser 10. The fluid dispenser 10 of FIG. 11 differs from the fluid dispensers of FIGS. 1A, 1B and 9 in that the spring 30, which is shown in greater detail in FIG. 12, comprises a plurality of resiliently deformable polymer units 38 which are each solid. In other words, each unit 38 of the spring 30 is substantially without a cavity. Therefore, the units 38 are not in fluid communication with one another or the outside environment. The units 38 are stacked vertically one on top of another and are housed entirely inside the housing 32 of the dispenser 10. The spring 30 is housed in a cavity 36 between the housing 32 and the stem 26. In a further embodiment, the spring may be a polymeric foam.

With reference to FIG. 12, the spring 30 has a non-helical arrangement. Each unit 38 has a substantially circular vertical cross section and is substantially ring shaped to form the opening 42 through which the stem of a fluid dispenser 10 extends.

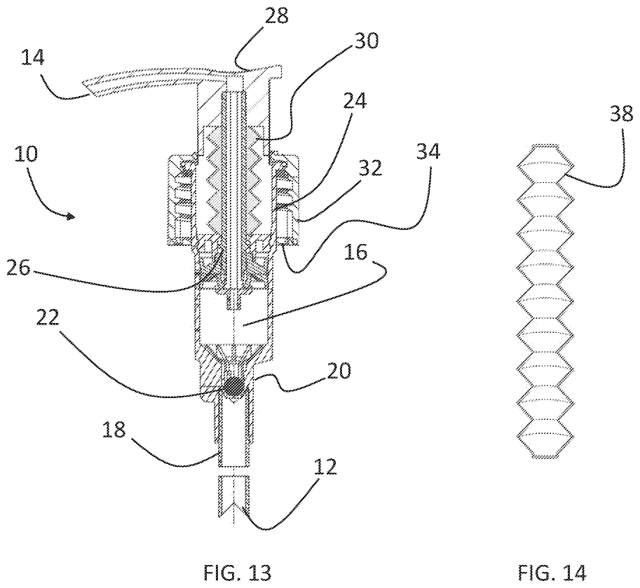

FIG. 13 shows a further fluid dispenser 10 having a spring 30 which is entirely housed within the housing 32.

The spring 30, shown in greater detail in FIG. 14, comprises a plurality of resiliently deformable polymer units 38 which are each substantially without a cavity. The spring 30 has a concertinaed arrangement. Each unit 38 comprises a top and bottom ends. The circumferential wall of each unit decreases in diameter towards each end of the unit 38. Each unit 38 thus has an equator which is substantially perpendicular to the longitudinal axis of the fluid dispenser 10. In other words, the spring comprises a succession of portion which are frustoconical where adjacent frustoconical portions taper in opposite directions. The succession of the portions allows the spring to collapse on itself under appropriate pressure and return to its starting configuration once pressure ceases to be applied.

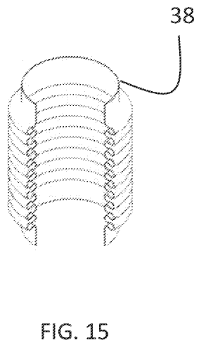

FIG. 15 shows an alternative configuration to the succession of frustoconical portions. Instead, the wall of the spring undulates as a succession of radiused portions which have alternatively an outer opening or an inner opening. These rounded sections are thus also susceptible to being collapsed when appropriate pressure is applied and then return to their original position once the pressure ceases to be applied for example once the fluid has been dispensed.

1. A fluid dispenser comprising:
a fluid inlet and a fluid outlet;
a pump for drawing fluid from a fluid source via the fluid inlet towards the fluid outlet;
wherein the pump has a push top with an external wall which surrounds the upper portion of a spring; said push top being displaceable within a housing;
said spring being adapted to bias the pump away from a compressed position and towards a rest position; the spring being, whilst in use, wholly internal as it is situated entirely within the combination of said push top and said housing;
wherein the spring is wholly formed of one or more resiliently deformable polymer units; and
said polymer units surround a stem through which fluid is drawn between said fluid inlet and said fluid outlet;
said stem extending along the entire length of said spring; whereby said stem separates said spring from said fluid.

2. A fluid dispenser according to claim 1, wherein each unit of the spring has a circumferential wall and the circumferential wall is substantially without a cavity.

3. A fluid dispenser according to claim 1, wherein the or each unit is a gas-fillable unit.

4. A fluid dispenser according to claim 2, wherein the spring has a substantially non-helical arrangement.

5. A fluid dispenser according to claim 4, wherein the spring comprises a plurality of vertically stacked units which are joined to one another such that the spring is formed as a single piece.

6. A fluid dispenser according to claim 5, wherein each unit has a substantially circular vertical cross section.

7. A fluid dispenser according to claim 5, wherein the spring is substantially concertinaed.

8. A fluid dispenser according to claim 7, wherein the spring is entirely contained within the housing.

9. A fluid dispenser according to claim 8, wherein adjacent units of the spring are in fluid communication with one another.

10. A fluid dispenser according to claim 9, wherein the spring is sealed from the outside environment.

11. A fluid dispenser according to claim 10, wherein the spring has a substantially constant diameter along a longitudinal axis of the spring.

12. A fluid dispenser according to claim 1, wherein the or each unit of the spring comprises an equator, the equator of the or each unit being perpendicular to a longitudinal axis of the spring.

13. A fluid dispenser according to claim 12, wherein the thickness of the or each unit is substantially constant along the length of the spring.

14. A fluid dispenser according to claim 13, wherein the thickness of the or each unit varies along the length of the spring.

15. A fluid dispenser according to claim 4, wherein the spring is coated with a non-stick coating.

16. A fluid dispenser according to claim 1, wherein the spring is made of an elastomer.

17. A fluid dispenser according to claim 1, wherein the spring is made of a thermoplastic elastomer.

18. A fluid dispenser according to claim 1, wherein the spring is made from material selected from the group of: a polyolefin blend (TPO); a polyolefin alloy (TPV); a polyolefin plastomer (POP); a polyolefin elastomer (POE); reactor TPO (R-TPO); a thermoplastic polyolefin; an olefin block copolymer.

19. A container comprising a fluid dispenser as provided by claim 1.

20. A container according to claim 19, wherein the container is an airless container.
